(19) United States
(12) Patent Application Publication
(10) Pub. No.: US 2023/0057618 A1
(43) Pub. Date: Feb. 23, 2023

(54) System and Method for Calculating and Displaying Aftermarket Wheel and Tire Size

(71) Applicant: William Sasner, Panorama City, CA (US)

(72) Inventor: William Sasner, Panorama City, CA (US)

(21) Appl. No.: 17/834,485

(22) Filed: Jun. 7, 2022

Related U.S. Application Data
(60) Provisional application No. 63/233,809, filed on Aug. 17, 2021.

(51) Int. Cl. G06Q 30/06; B60C 99/00

(52) U.S. Cl. CPC G06Q 30/0643; B60C 99/006; G06F 3/0482

(57) ABSTRACT

This present invention relates to a system and method using a computer implemented wheel fit application for calculating/determining and displaying aftermarket wheel size and tire size for automobiles and vehicles. The computer implemented application is compatible with any smart device, including smart phones, laptops, multiple computer operating systems, and tablets. The application displays drop-down menus for a vehicle's year, make, model, and trim enabling a user to select a vehicle and as a result displays appropriate or compatible aftermarket wheel and tire sizes. The application allows users to purchase correct (i.e. compatible) sized tires and wheels and obviates returning and exchanging of incompatible sized tires and wheels.

### CROSS-REFERENCE TO RELATED APPLICATION

The present application claims priority to, and the benefit of, U.S. Provisional Application No. 63/233,809 which was filed on Aug. 17, 2021, and is incorporated herein by reference in its entirety.

### FIELD OF THE INVENTION

The present invention relates generally to the field of wheel/tire inspection. More specifically, the present invention relates to a method of calculating/determining aftermarket wheel and tire size for various automobiles, sport-utility vehicles, trucks and more. The wheel and tire size are calculated and displayed using a computer implemented application that is compatible with electronic devices such as mobile phones, laptops, tablet devices and the like. The application obviates any hassles due to buying of wheels and tires of incorrect sizes and ensures peace of mind of the users. Accordingly, the present disclosure makes specific reference thereto. Nonetheless, it is to be appreciated that aspects of the present invention are also equally applicable to other like applications, devices, and methods of manufacture.

### BACKGROUND

By way of background, many individuals like to customize the exterior of their cars to their liking as a means of personal expression. Individuals may desire to change the wheels or tires frequently in order to change the looks of their vehicles. However, while shopping for aftermarket wheels and tires, individuals can be unsure of the correct size of tires/wheels that would fit onto their vehicle, and therefore, can be reluctant to purchase aftermarket larger size wheels with low-profile tires. In situations where a person buys an incorrectly sized wheel or tire that does not fit onto their vehicle, then it will be a waste of money to the user. Additionally, even if the incorrectly sized wheels and tires are returnable or exchangeable, then it takes a lot of time and can be frustrating for the vehicle owners.

Further, individuals usually travel to any nearby or distant tire market or outlet for buying aftermarket wheels and tires and are required to take out time from their busy schedules to visit the markets/stores. In situations where an incorrect wheel/tire is bought, then it may take multiple visits to the market/store to return or exchange the aftermarket wheels and tires. This may waste a lot of time and money of the user.

Some individuals may take measurements of the wheels and tires of the vehicles using traditional measurement devices. However, individuals may fail to get correct and exact measurement details for wheels/tires and may end up buying incorrectly sized wheels/tires. This can be again frustrating for the users. Also, individuals with limited physical dexterity may have problems in taking the measurements of wheels/tires and may require assistance from others.

The consumers need a device or application that will provide correct measurements for their individual vehicles before purchase to ensure clearance in the vehicle wheel well. This may save time, effort, and money of the consumers.

Therefore, there exists a long felt need in the art for a method for providing measurements of wheels and tires of various types of vehicles. There is also a long felt need in the art for a method that can be conveniently used by individuals to get exact and correct measurements for wheels and tires of vehicles before purchase of aftermarket wheels/tires. Additionally, there is a long felt need in the art for a wheel/tire size calculation method that ensures consumers buy correctly sized aftermarket wheels and tires. Moreover, there is a long felt need in the art for a wheel/tire size calculation method that eliminates the need to return/exchange aftermarket wheels/tires and ensures consumers obtain wheels/tires that fit to their vehicles. Further, there is a long felt need in the art for a wheel/tire size calculation method that eliminates the need to manually measure the wheel size or tire size of the vehicles before purchasing aftermarket wheels/tires. Furthermore, there is a long felt need in the art for a wheel/tire measurement calculation method that offers peace of mind to the consumers. Finally, there is a long felt need in the art for a wheel/tire size calculation method that provides wheel/tire measurement for automobiles, sport-utility vehicles, trucks, and the like, and obviates the consumers from purchasing incorrectly sized wheels and tires.

The subject matter disclosed and claimed herein, in one embodiment thereof, comprises a computer implemented method for calculating/determining and displaying aftermarket wheel and tire size for vehicles by using at least one processor and at least one non-transitory storage device storing executable code stored in an electronic device. The method includes the steps of receiving, with the at least one processor, user inputs including vehicle make, year, model, and trim to select a subject vehicle; receiving, with the at least one processor, wheel size of the selected vehicle; displaying, with the at least one processor, appropriate or compatible aftermarket tire sizes compatible with the vehicle and the wheel size; receiving, with the at least one processor, a selection of one of the displayed tire sizes; and receiving, with the at least one processor, a purchase request of the selected tire size.

In this manner, the aftermarket wheel and tire size computer implemented system and associated method of the present invention accomplishes all of the forgoing objectives and provides users with a mobile application for calculating/determining aftermarket wheel and tire size. The invention offers user peace of mind that they are purchasing the correct wheel and tire size for automobiles, sport-utility vehicles, and trucks.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a computer implemented method for calculating/determining and displaying aftermarket wheel and tire size for vehicles by using at least one processor and at least one non-transitory storage device storing executable code. The method includes the steps of receiving, with the at least one processor, input indicating vehicle make, year, model, and trim of a subject vehicle; receiving, with the at least one processor, wheel size of the vehicle; displaying, with the at least one processor, appropriate or compatible aftermarket tire sizes compatible with the vehicle and the wheel size; receiving, with the at least one processor, a selection of one of the displayed tire sizes; and receiving, with the at least one processor, a purchase request of the selected tire size.

In yet another embodiment, a non-transitory computer readable storage medium storing one or more executable programs, the programs comprising the instructions for presenting one or more graphical user interfaces, the graphical user interfaces include drop-downs for vehicle make, vehicle year, vehicle model, vehicle trim; the programs configuring a processor to display a list containing tire sizes compatible to a vehicle selected based on said drop-downs; receiving a selection of a tire size from said list; and displaying an avatar of the selected vehicle equipped with tires of selected tire size.

In yet another embodiment, one or more computer-readable storage media comprising a plurality of instructions that in response to being executed cause an electronic device to generate a first graphical user interface for selecting a vehicle and displaying appropriate or compatible aftermarket tire sizes for the vehicle; generate a second graphical user interface for displaying a comparison of current tire size and a desired tire size for a vehicle; and generate a third graphical user interface for enabling users to purchase a tire.

In yet another embodiment, a computer implemented system is disclosed. The system includes at least one processor in a server, a non-transitory computer-readable storage medium comprising instructions, that when executed, control the one or more computer processors to be configured for presenting one or more graphical user interfaces, the graphical user interfaces include dropdowns for vehicle make, vehicle year, vehicle model, vehicle trim and avatar of a vehicle selected based on said dropdowns. The graphical user interface also displays a list of compatible tire sizes with the selected vehicle.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a schematic view of one potential embodiment of a wheel size calculator system of the present invention for calculating/determining aftermarket wheel and tire size for vehicles in accordance with the disclosed architecture;

FIG. 2 illustrates an exemplary user interface of the wheel fit software application for showing appropriate or compatible tire sizes in accordance with the disclosed architecture;

FIG. 3 illustrates another graphical user interface of the wheel fit software application for showing appropriate or compatible tire sizes in accordance with the disclosed architecture;

FIG. 4 illustrates a flow diagram depicting exemplary steps performed by the software application for displaying tires that may fit for a selected vehicle in accordance with the disclosed architecture;

FIG. 5 illustrates a yet another exemplary user interface provided by the wheel fit software application of the present invention in accordance with the disclosed architecture;

FIG. 6 illustrates a flow diagram depicting a process of enabling users to purchase recommended appropriate or compatible tires using the software application in accordance with the disclosed architecture; and

FIG. 7 illustrates an exemplary user device that is used for installing the wheel fit software application of the present invention in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It can be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments can be combined.

As noted above, there is a long felt need in the art for a method for providing measurements of wheels and tires of various types of vehicles. There is also a long felt need in the art for a method that can be conveniently used by individuals to get exact and correct measurements for wheels and tires of vehicles before purchase of aftermarket wheels/tires. Additionally, there is a long felt need in the art for a wheel/tire size calculation method that ensures consumers buy correctly sized aftermarket wheels and tires. Moreover, there is a long felt need in the art for a wheel/tire size calculation method that eliminates the need to return/exchange aftermarket wheels/tires and ensures consumers get wheels/tires that fit onto their vehicles. Further, there is a long felt need in the art for a wheel/tire size calculation method that eliminates the need to manually measure the wheel size or tire size of the vehicles before purchasing aftermarket wheels/tires. Furthermore, there is a long felt need in the art for a wheel/tire measurement calculation method that offer peace of mind to the consumers. Finally, there is a long felt need in the art for a wheel/tire size calculation method that provides wheel/tire measurements for automobiles, sport-utility vehicles, trucks, and the like, and obviates the consumers from purchasing incorrectly sized wheels and tires.

The present invention, in one exemplary embodiment, is a novel one or more computer-readable storage media comprising a plurality of instructions that in response to being executed cause an electronic device to generate a first graphical user interface for selecting a subject vehicle and displaying appropriate or compatible aftermarket tire sizes for the vehicle; generate a second graphical user interface for displaying a comparison of current tire size and a desired tire size for a vehicle; and generate a third graphical user interface for enabling users to purchase a tire.

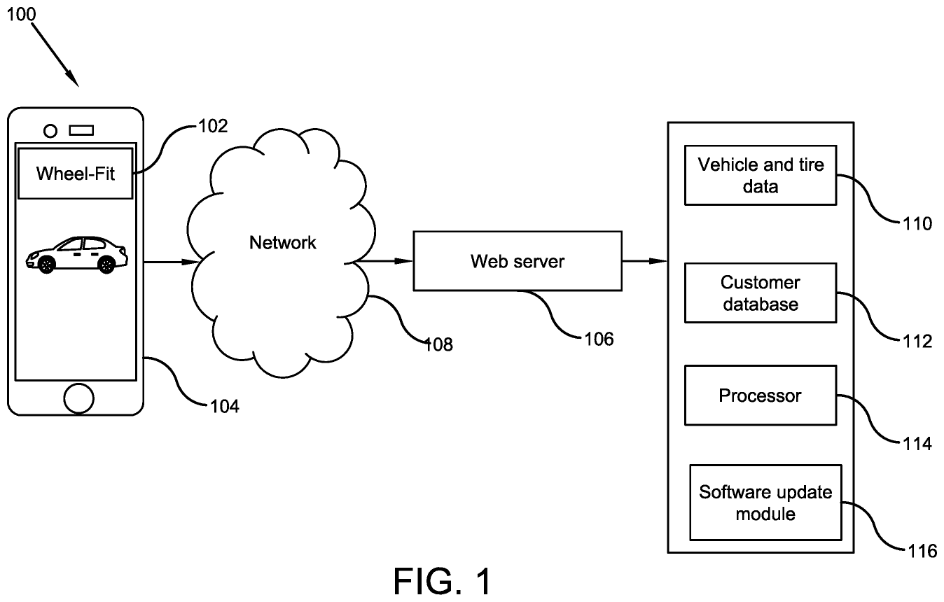

Referring initially to the drawings, FIG. 1 illustrates a schematic view of one potential embodiment of the wheel size calculator system of the present invention for calculating/determining aftermarket wheel and tire size for vehicles in accordance with the disclosed architecture. The wheel size calculator system 100 of the present invention is designed to provide users a computer implemented software application 102 installed in any smart device 104 including, but not limited to, smart phones, laptops, multiple computer operating systems, smart watches, wearable smart devices, and tablets for providing acceptable aftermarket wheels and tire sizes for any given vehicle. The Wheel fit software application 102 is used for calculating/determining the appropriate or compatible tire size and thus helps in eliminating poor tire performance or possible wheel and/or tire failure.

More specifically, the system 100 includes a computer implemented server 106 which can be in the form of a central server, cloud-based server, or distributed server. The server 102 is configured to provide a plurality of graphical user interfaces (GUI) on the application 102 accessed by users through their electronic devices 104 for calculating/determining tire and wheel sizes. The server 102 can be realized through various web-based technologies such as, but not limited to, a Java web-framework, a .NET framework, a personal home page (PHP) framework, or any web-application framework.

The software application 102 includes computer readable instructions readable by the processor of the electronic device 104 for displaying the user interfaces and calculated aftermarket tire sizes. It should be appreciated that the system and functionality of the present invention can work using a website in a manner like the software application 102. The GUIs on both the application and the website are similar, are scaled, and formatted to fit within a display of the electronic devices.

A communication network 108 such as Internet or any public or private network is used for communication between the mobile application 102 and the server 106. The communication network 108 may include a wireless channel, a wired channel, a combination of wireless and wired channel thereof. The wireless or wired channel can be associated with a data standard which can be defined by one of a Local Area Network (LAN), a Personal Area Network (PAN), a Wireless Local Area Network (WLAN), a Wireless Sensor Network (WSN), Wireless Area Network (WAN), Wireless Wide Area Network (WWAN), a metropolitan area network (MAN), a satellite network, the Internet, a fiber optic network, a coaxial cable network, an infrared (IR) network, a radio frequency (RF) network, and a combination thereof. Embodiments of the present invention are intended to include or otherwise cover any type of communication channel, including known, related art, and/or later developed technologies.

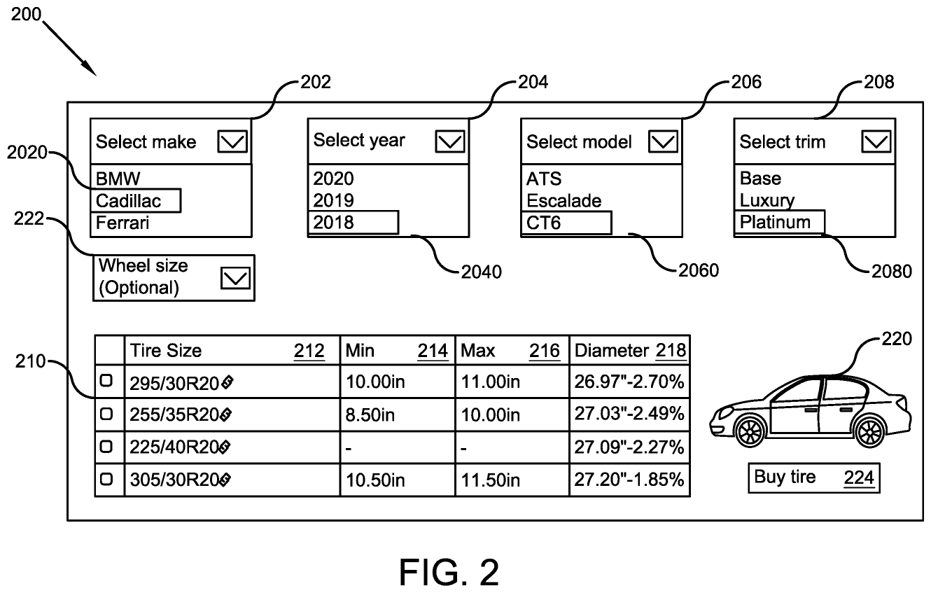

The server 106 is associated with a vehicle and tire database 110 used for storing the tire and wheel information for all types of vehicles for all makes. The database 110 is continuously updated to include the new models of vehicles introduced by makes and also the updated acceptable tire and wheel sizes for vehicles. A user accessing the software application 102 retrieves the stored content in the database 110 in a format suitable for display of their electronic device as illustrated in FIGS. 2, 3, and 5. A customer database 112 securely stores information of customers/users of the system 100. The information may include, but not limited to, name, location, age, gender, payment method, and more.

The server 106 has a processor 114 for executing processing of instructions of the server 106. The processor 114 can be any type of processor or combination of processors capable of executing software/firmware, such as a one or more microprocessors, digital signal processors, microcontrollers, or the like. The processor 114 can be a single processor or may include multiple processors.

A software update module 116 configures any update in the software application 102. The updates can be in the functionality offered by the application 102 and also updates in the layout of the application 102. The software update module 116 is specifically configured to generate a software release. The software release may include multiple release components and a release version number. The release components can be organized in a hierarchical structure of files, packages, bundles, or other components.

FIG. 2 illustrates an exemplary user interface of the wheel fit software application for showing appropriate or compatible tire sizes in accordance with the disclosed architecture. The graphical user interface 200 is used for receiving simple inputs from a user and displaying appropriate or compatible tire sizes for the chosen vehicle by the user. As illustrated, a vehicle manufacturer is selected by the user from the vehicle make drop down 202. On clicking the vehicle make drop down list 202, a drop-down list 2020 of automobile manufacturers is displayed and any one of the makes is chosen by the user. For the chosen manufacturer, a model year is selected from the list 2040 using the vehicle year drop down list 204. The vehicle year drop down tab 204 displays a list 2040 of years from which any desired vehicle year can be selected by the user.

For the selected manufacturer and the selected year, a specific vehicle model is selected from a drop-down list 2060 of vehicle models displayed upon clicking the select vehicle model tab 206. Once the make, year, and model are chosen, then, a trim 2080 for the selected vehicle model is chosen using the select trim drop down 208. Based on the selected said parameters, a list 210 of appropriate or compatible tire sizes is displayed on the interface 200 for the user.

The tire list 210 includes multiple rows wherein each row contains an appropriate or compatible tire size 212, minimum width 214, maximum width 216 and diameter 218 of the tire. Further, the rows are selectable and when a row is selected, an avatar 220 of the selected vehicle by the user is displayed with the selected tire virtually installed in the avatar 220. The interface also allows users to buy a selected tire from the application 102 using the Buy tire option 224.

For enabling users to identify appropriate or compatible tire sizes based on a certain wheel size in their vehicle, the interface 200 allows users to select a specific wheel size using the wheel size drop down 222. The wheel size drop-down 222 can be optional and can be selected as per preference of a user.

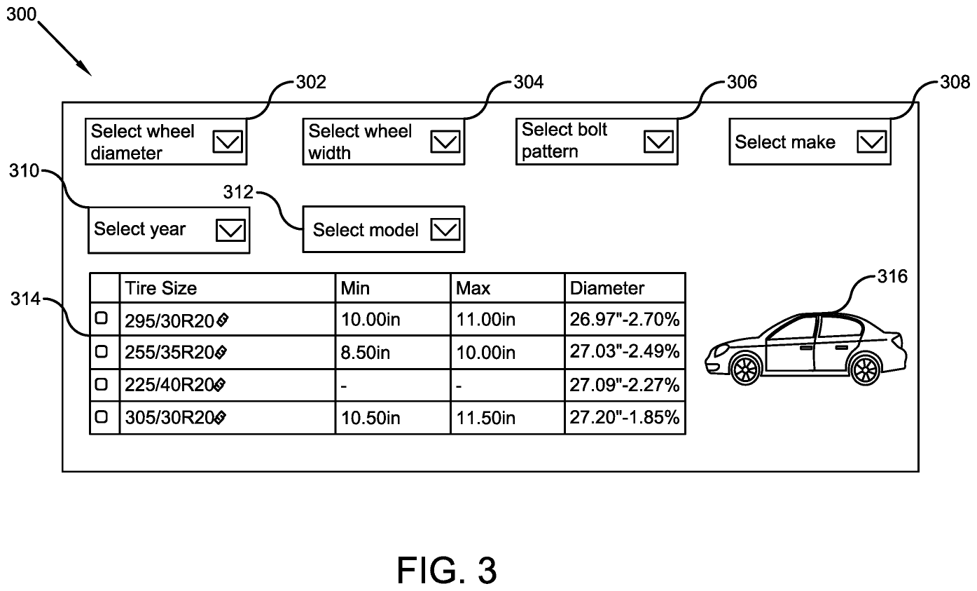

FIG. 3 illustrates another graphical user interface of the wheel fit software application for showing appropriate or compatible tire sizes in accordance with the disclosed architecture. The user interface 300 of the present embodiment is useful for individuals who like to modify their vehicle by deploying a new wheel and tires. A wheel diameter is selected by a user from a wheel diameter drop-down 302. After selection of the wheel diameter, wheel width is selected using the wheel width drop-down 304. Then, an appropriate or compatible type and pattern of wheel bolts are selected using bolt drop-down (i.e. select wheel bolt pattern) 306.

After the wheel selection, an automobile maker or manufacturer is selected using the select make drop-down 308. A select year drop-down 310 and a select model drop-down 312 are used for shortlisting a vehicle for which appropriate or compatible tire sizes are required by a user. It should be noted that the sequence and positioning of the drop-down menus of the interface 300 can be in any order as per requirements of users.

A tire list 314 is displayed on the interface 300 containing a list of appropriate or compatible tires having necessary information for selection of a tire by a user. The tire list 314 can be similar to the tire list 210 of FIG. 2. An avatar 316 of the selected vehicle with selected wheel size is displayed enabling the users to view the installation of the selected tires from the list 314 in the avatar 316.

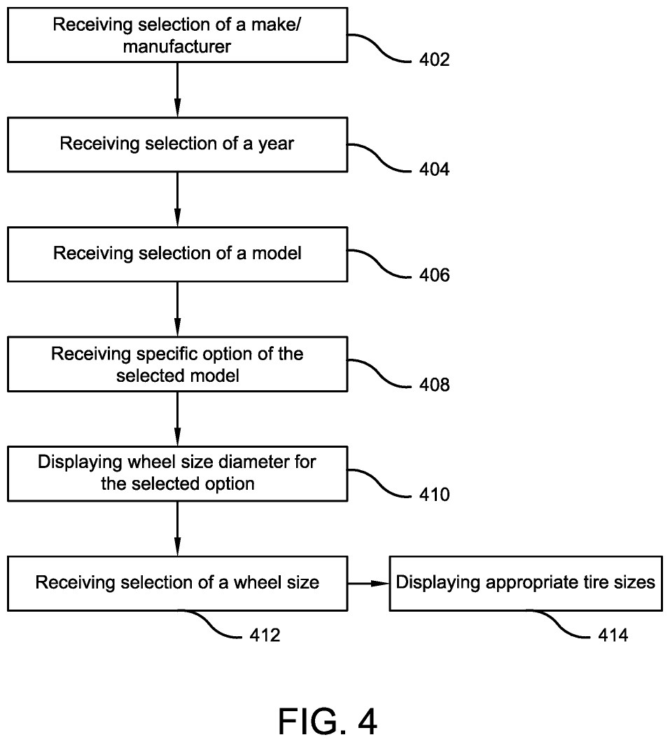

FIG. 4 illustrates a flow diagram depicting exemplary steps performed by the software application 102 for displaying tires that may fit for a selected vehicle in accordance with the disclosed architecture. Initially, the software application receives a selection of a make/manufacturer of a vehicle (Step 402). The maker can be received by selection from a drop-down list or alternatively users can type a make name in a text box. Then, a year in which the vehicle is manufactured and a selection of vehicle model are received by the software application (Steps 404,406). In situations wherein the model has a plurality of options (trims), then a specific trim is chosen of the model (Step 408).

Based on the received parameters, appropriate or compatible wheel sizes along with parameters like wheel width, diameter, and more are displayed to the users on the interface (Step 410). From the displayed list of wheel sizes, a selection of a specific wheel size is received by the software application from a user (Step 412). A list of aftermarket tire sizes compatible to the wheel size and the vehicle is displayed enabling a user to choose for buying the tires and thereby eliminating any misfit of aftermarket tires (Step 414).

It should be noted that the sequence of any of the steps in the flow diagram can be changed without affecting the objective of providing a list of appropriate or compatible tires to a user.

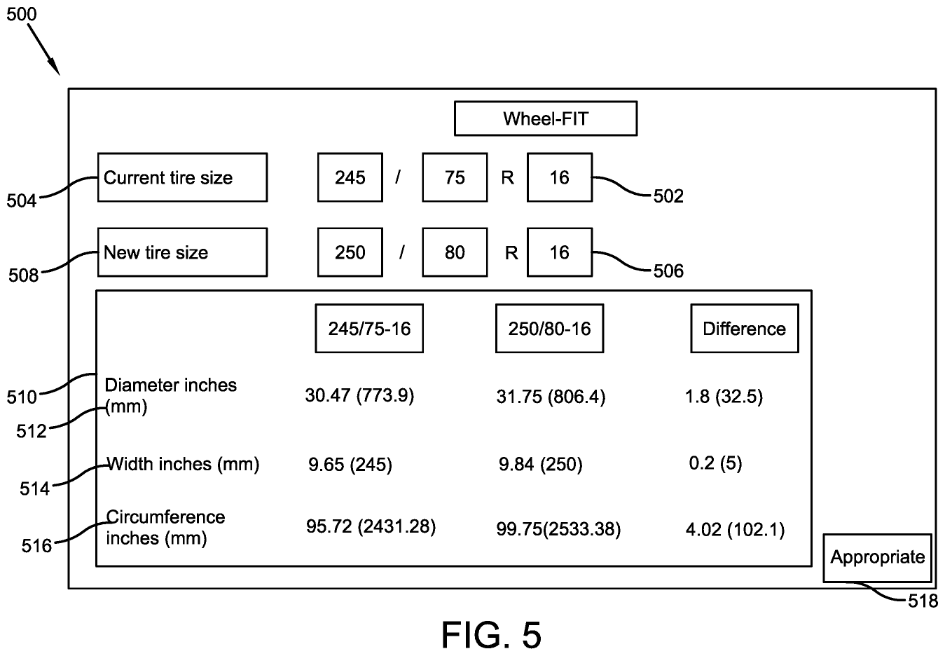

FIG. 5 illustrates a yet another exemplary user interface provided by the wheel fit software application of the present invention in accordance with the disclosed architecture. In the interface 500, current tire size of a vehicle is input by a user in the text boxes 502 adjacent to the current tire size text or first tire size text 504. A new desired tire size or second tire size for the vehicle can be input into the text boxes 506 positioned adjacent to the new tire size or second tire size 508. The interface 500 allows the software application 102 to display comparison of the current tire size (i.e. first size) and the new tire size (i.e. second size) in the form of a comparison table 510. The comparison table 510 displays comparison of tire diameter 512, tire width 514, and tire circumference 516.

The software application 102 also provides a recommendation such as Appropriate 518 for example, thereby recommending to users that the new tire size is compatible or appropriate for installation when compared with the current tire size.

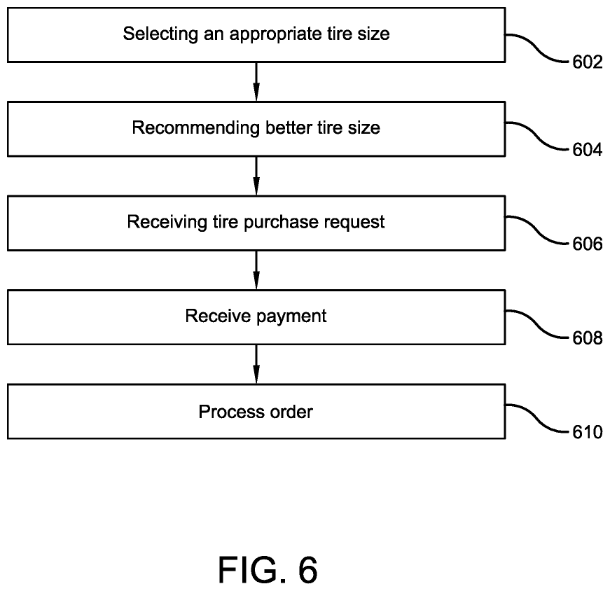

FIG. 6 illustrates a flow diagram depicting a process of enabling users to purchase recommended compatible and/or appropriate tires using the software application 102 in accordance with the disclosed architecture. Initially, from a list of appropriate or compatible tire sizes displayed by the application, an appropriate or compatible tire is selected by a user and the selection is received by the application (Step 602). In situations where a more appropriate or compatible tire size is available, then, the application recommends the tire size to the user (Step 604). Thereafter, a purchase request of tires is received by the application (and the server) (Step 606) and a payment using a preferred payment method is also received from the user (Step 608). After receiving the payment, the order is processed and the tires can be physically dispatched to the user or can be available at a predefined location (Step 610).

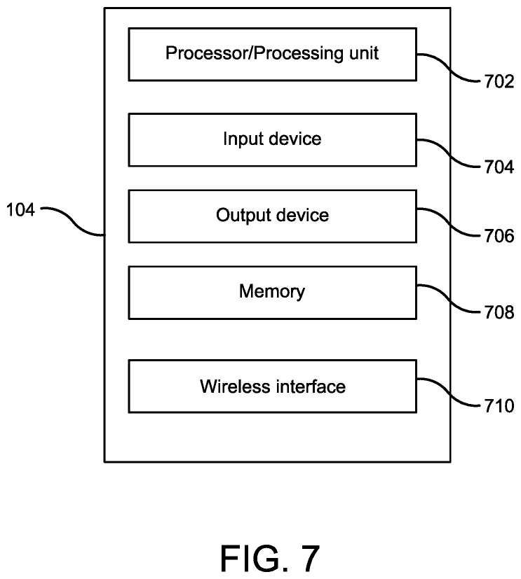

FIG. 7 illustrates an exemplary user device 104 that is used for installing the wheel fit software application 102 of the present invention in accordance with the disclosed architecture. The processing unit 702 may include suitable logic, instructions, circuitry, interfaces, and/or codes for executing various operations, such as the operations associated with the user device 104, or the like. The processing unit 702 can be configured to control one or more operations executed by the user device 104 in response to the input received at the user device 104 from the user. The processor 702 executes the computer readable instructions stored in the application 102. Examples of the processing unit 702 may include, but are not limited to, an application-specific integrated circuit (ASIC) processor, a reduced instruction set computing (RISC) processor, a complex instruction set computing (CISC) processor, a field-programmable gate array (FPGA), a Programmable Logic Control unit (PLC), and the like. Embodiments of the present disclosure are intended to include or otherwise cover any type of the processing unit 702 including known, related art, and/or later developed processing units. The user device 104 can further include one or more computer executable applications configured to be executed by the processing unit 702. The one or more computer executable applications may include suitable logic, instructions, and/or codes for executing various operations. The one or more computer executable applications can be stored in the memory 708.

The user device 104 includes input device(s) 704 such as a touch input device, voice input device, etc. for entering data and information. Preferably, the touch interface of the user device 104 is used as the input and various buttons/tabs shown on the application 102 are pressed or clicked by the user. Other input devices such as camera and microphone are used during video chatting by the user. The display of the user device 104 also acts as the output device 706 for displaying various contents (e.g., text, images, videos, icons, and/or symbols, etc.) to the user. The display can include a touch screen, and may receive, for example, a touch, gesture, proximity, or hovering input using an electronic pen or a part of a user's body.

Electronic device 104 has memory 708 used for storing programs (sequences of instructions) or data (e.g., program state information) on a temporary or permanent basis for use in the computer system. Memory 708 can be configured for short-term storage of information as volatile memory and therefore not retain stored contents if powered off. Examples of volatile memories include random access memories (RAM), dynamic random-access memories (DRAM), static random-access memories (SRAM), and other forms of volatile memories known in the art. The processor 702, in combination with one or more of memory 708, input device(s) 704, output device(s) 706 is utilized to provide users to execute instructions on the application 102. The connection to a network is provided by wireless interface 710.

The wireless interface 710 enables the user device 104 to communicate with the server 106 and other components of the system 100 over the communication network 108, according to embodiments of the present disclosure. Examples of the communication interface 710 may include, but are not limited to, a modem, a network interface such as an Ethernet card, a communication port, and/or a Personal Computer Memory Card International Association (PCMCIA) slot and card, an antenna, a radio frequency (RF) transceiver, one or more amplifiers, a tuner, one or more oscillators, a digital signal processor, a coder-decoder (CODEC) chipset, a subscriber identity module (SIM) card, and a local buffer circuit. It will be apparent to a person of ordinary skill in the art that the communication interface 710 may include any device and/or apparatus capable of providing wireless or wired communications between the user device 104 and the server 102.

As used herein, the term “server” refers to any computerized component, system, or entity regardless of form which is adapted to provide data, files, applications, content, or other services to one or more other devices or entities on a computer network.

As used herein, the term “user interface” or “graphical user interface” refers to, without limitation, any visual, graphical, tactile, audible, sensory, or other means of providing information to and/or receiving information from a user or other entity.

Embodiments of the present disclosure take the form of computer-executable instructions, including algorithms executed by a programmable computer. However, the disclosure can be practiced with other computer system configurations as well. Certain aspects of the disclosure can be embodied in a special-purpose computer or data processor that is specifically programmed, configured, or constructed to perform one or more of the computer-executable algorithms described below. Accordingly, the term “computer” as generally used herein refers to any data processor and includes Internet appliances, hand-held devices (including tablets, computers, wearable computers, cellular or mobile phones, multi-processor systems, processor-based or programmable consumer electronics, network computers, minicomputers) and the like.

Certain terms are used throughout the following description and claims to refer to particular features or components. As one skilled in the art will appreciate, different persons may refer to the same feature or component by different names. This document does not intend to distinguish between components or features that differ in name, but not structure or function. As used herein “system,” and “wheel size calculator system” are interchangeable and refer to the wheel size calculator system 100 of the present invention. Similarly, as used herein “software application,” “wheel size calculator software application,” and “application” are interchangeable and refer to the wheel size calculator software application 102 of the present invention.

Notwithstanding the forgoing, the wheel size calculator system 100 and the wheel size calculator software application 102 of the present invention can be of any suitable size and configuration as is known in the art without affecting the overall concept of the invention, provided that it accomplishes the above stated objectives. One of ordinary skill in the art will appreciate that the wheel size calculator system 100 and the wheel size calculator software application 102 as shown in the FIGS. are for illustrative purposes only, and that many other sizes and shapes of the wheel size calculator system 100 and the wheel size calculator software application 102 are well within the scope of the present disclosure. Although the dimensions of the wheel size calculator system 100 and the wheel size calculator software application 102 are important design parameters for user convenience, the wheel size calculator system 100 and the wheel size calculator software application 102 can be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer implemented software wheel fit application installed in a smart device for identifying vehicle tire and wheel compatibility, wherein the computer implemented software wheel fit application comprises:
a server including a plurality of graphical user interfaces (GUI) on a wheel fit application for accessing by a user through an electronic device;
wherein said server is associated with a vehicle tire and vehicle wheel information database used for storing said vehicle tire and said vehicle wheel information for a plurality of makes of vehicles;
said GUI further includes a user interface of said wheel fit application for displaying a tire size and a wheel size;
said GUI used for receiving vehicle information inputs from the user and displaying compatible tire sizes and wheel sizes for a subject vehicle by the user;
wherein said inputs include a subject vehicle make, a subject vehicle year, a subject vehicle model, and a subject vehicle trim;
wherein said wheel fit application identifying compatible tires and wheels for said subject vehicle;
wherein said wheel fit application displays a tire size, a tire minimum width, a tire maximum width, and a tire diameter for each said compatible tire;
wherein said wheel fit application calculates a tire circumference for each said compatible tire;
wherein said wheel fit application displays and compares at least a first tire diameter with at least a second tire diameter, at least a first tire width with at least a second tire width, and at least a first tire circumference with at least a second tire circumference; and
wherein said wheel fit application displays a difference between said at least first tire diameter and said at least second tire diameter, a difference between said at least first tire width and said at least second tire width, and a difference between said at least first tire circumference and said at least second tire circumference.

2. The computer implemented software wheel fit application of claim 1, wherein said server is selected from a group consisting of a central server, a cloud-based server, and a distributed server.

3. The computer implemented software wheel fit application of claim 1, wherein said inputs further includes a wheel diameter.

4. The computer implemented software wheel fit application of claim 3, wherein said inputs further includes a wheel width.

5. The computer implemented software wheel fit application of claim 4, wherein said inputs further includes a wheel bolt pattern.

6. The computer implemented software wheel fit application of claim 1, wherein said wheel fit application display includes a first row of at least a first tire size, a first tire minimum width, a first tire maximum width, and a first tire diameter, and a second row of at least a second tire size, a second tire minimum width, a second tire maximum width, and a second tire diameter.

7. The computer implemented software wheel fit application of claim 6, wherein said at least first tire is a current tire and said at least second tire is a recommended tire.

8. The computer implemented software wheel fit application of claim 7 further comprising a tire purchase request function.

9. The computer implemented software wheel fit application of claim 8 further comprising a tire purchase payment function.

10. The computer implemented software wheel fit application of claim 6 further comprising an avatar of said subject vehicle and a pair of selected said compatible tires virtually installed on said avatar.

11. The computer implemented software wheel fit application of claim 10, wherein said smart device is selected from a group consisting of a smart phone, a laptop, a computer operating system, a smart watch and a tablet.

12. A computer implemented software wheel fit application installed in a smart device for identifying a vehicle tire and wheel compatibility, wherein the computer implemented software wheel fit application comprises:
a server including a plurality of graphical user interfaces (GUI) on a wheel fit application for accessing by a user through an electronic device;
wherein said server associated with a vehicle tire and vehicle wheel information database used for storing said vehicle tire and said vehicle wheel information for a plurality of makes of vehicles;
said GUI further includes a user interface of said wheel fit application for displaying a tire size and a wheel size;
said GUI used for receiving vehicle information inputs from the user and displaying compatible tire sizes and wheel sizes for a subject vehicle by the user;
wherein said inputs include a subject vehicle make, a subject vehicle year, a subject vehicle model, a subject vehicle trim, a wheel diameter, a wheel width, and wheel bolt pattern;
wherein said wheel fit application identifying compatible tires and wheels for said subject vehicle;
wherein said wheel fit application displays a tire size, a tire minimum width, a tire maximum width, and a tire diameter for each said compatible tire;
wherein said wheel fit application displays and compares at least a first tire diameter with at least a second tire diameter, at least a first tire width with at least a second tire width, and at least a first tire circumference with at least a second tire circumference; and
wherein said wheel fit application displays a difference between said at least first tire diameter and said at least second tire diameter, a difference between said at least first tire width and said at least second tire width, and a difference between said at least first tire circumference and said at least second tire circumference.

13. The computer implemented software wheel fit application of claim 12, wherein said wheel fit application display includes a first row of at least a first tire size, a first tire minimum width, a first tire maximum width, and a first tire diameter, and a second row of at least a second tire size, a second tire minimum width, a second tire maximum width, and a second tire diameter.

14. A computer implemented method for determining a tire and wheel compatibility for a vehicle, the method comprising the steps of:
installing a wheel fit application in a smart device for identifying a vehicle tire and vehicle wheel compatibility;
accessing said wheel fit application through a server and a plurality of graphical user interfaces (GUI) on said wheel fit application by a user through said smart device;
storing said vehicle tire and said vehicle wheel information in a vehicle wheel information database for all makes of vehicles through said server;
wherein said GUI further includes a user interface of said wheel fit application for displaying a tire size and a wheel size;
receiving vehicle information inputs from the user through said GUI;
wherein said inputs include a subject vehicle make, a subject vehicle year, a subject vehicle model, and a subject vehicle trim;
identifying compatible tire sizes and wheel sizes for a subject vehicle by the user;
displaying compatible tires and wheels for said subject vehicle;
displaying a tire size, a tire minimum width, a tire maximum width, and a tire diameter for each said compatible tire;
calculating a tire circumference for each said compatible tire;
displaying and comparing at least a first tire diameter with at least a second tire diameter, at least a first tire width with at least a second tire width, and at least a first tire circumference with at least a second tire circumference; and
displaying a difference between said at least first tire diameter and said at least second tire diameter, a difference between said at least first tire width and said at least second tire width, and a difference between said at least first tire circumference and said at least second tire circumference.

15. The method of claim 14, wherein said inputs further includes a wheel diameter, a wheel width, and a wheel bolt pattern.

16. The method of claim 14, wherein said wheel fit application display includes a first row of at least a first tire size, a first tire minimum width, a first tire maximum width, and a first tire diameter, and a second row of at least a second tire size, a second tire minimum width, a second tire maximum width, and a second tire diameter.

17. The method of claim 16, wherein said at least first tire is a current tire and said at least second tire is a recommended tire.

18. The method of claim 14 further comprising a tire purchase request function.

19. The method of claim 14 further comprising an avatar of said subject vehicle and a pair of selected said compatible tires virtually installed on said avatar.

20. The method of claim 19, wherein said smart device is selected from a group consisting of a smart phone, a laptop, a computer operating system, a smart watch and a tablet.
